(19) United States
(12) Patent Application Publication
(10) Pub. No.: US 2025/0318514 A1
(43) Pub. Date: Oct. 16, 2025

(54) SYSTEM AND METHOD FOR AN AGRICULTURAL APPLICATOR

(71) Applicant: CNH Industrial America LLC, New Holland, PA (US)

(72) Inventors: Benjamin Smith, Brillion, WI (US); Roy A. Bittner, Reedsville, WI (US)

(21) Appl. No.: 18/634,186

(22) Filed: Apr. 12, 2024

(51) Int. Cl. A01M 7/00; A01B 73/06; A01C 23/00; B05B 1/20; B05B 12/08; B05B 15/72

(52) U.S. Cl. CPC A01M 7/0057; A01B 73/065; A01C 23/008; A01M 7/0075; B05B 1/20; B05B 12/08; B05B 15/72

(57) ABSTRACT

A system is provided herein that may include a boom assembly. A first actuator and a second actuator may be operably coupled with the boom assembly and configured to alter a position of the boom assembly. A control circuit may be fluidly coupled with the first actuator and the second actuator. The control circuit may include a fluid control valve configured to restrict a flow of hydraulic fluid in a first position to allow movement of the first actuator and the second actuator and restrict the flow of hydraulic fluid in a second position to allow movement of the first actuator and the second actuator.

### FIELD

The present disclosure generally relates to agricultural implements and, more particularly, to systems and methods for spray operations.

### BACKGROUND

Various types of vehicles utilize applicators (e.g., vehicles, floaters, etc.) to deliver an agricultural product to a ground of a field. The agricultural product may be in the form of a solution or mixture, with a carrier (such as water) being mixed with one or more active ingredients (such as an herbicide, fertilizer, fungicide, a pesticide, or another product).

The applicators may be pulled as an implement or self-propelled and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom sections, each with a number of spray nozzles (also sometimes referred to as spray tips).

During a spray operation, the vehicle drives over a target to direct the agricultural product at the target. However, the various factors may cause the boom arm to move thereby placing various sections of the boom arms at heights that are varied from a defined height above the target. Accordingly, a vehicle that is capable of altering a height of the boom assembly would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to a system that includes a boom assembly. A mast is operably coupled with the boom assembly. A first roll actuator and a second roll actuator are operably coupled with the boom assembly and the mast. Actuation of the first roll actuator or the second roll actuator causes the boom assembly to move relative to the mast. A control circuit is operably coupled with the first roll actuator and the second roll actuator. The control circuit includes a roll flow valve fluidly coupled with a pressure line. A roll directional control valve is downstream of and fluidly coupled with the roll flow valve. The roll directional control valve is further fluidly coupled with a tank line. A fluid control valve is upstream of the roll flow valve and configured to allow a flow of hydraulic fluid in a first position to allow movement of the first roll actuator or the second roll actuator and restrict the flow of hydraulic fluid in a second position to lock the roll flow valve. A computing system is operably coupled with the control circuit and configured to actuate the fluid control valve between the first position and the second position based at least in part on mode of operation of the boom assembly.

In some aspects, the present subject matter is directed to a method for an operation of a system for a boom assembly. The method includes determining, with a computing system, a mode of operation of a vehicle. The method also includes allowing, with the computing system, a flow of hydraulic fluid through a fluid control valve to one or more actuators operably coupled with a boom assembly when the mode is engaged to alter a position of the boom assembly. Lastly, the method includes restricting, with the computing system, the flow of the hydraulic fluid through the fluid control valve to one or more actuators operably coupled with the boom assembly when the mode is not engaged to restrict movement of the boom assembly.

In some aspects, the present subject matter is directed to a system that includes a boom assembly. A first actuator and a second actuator are operably coupled with the boom assembly and configured to alter a position of the boom assembly. A sensor system is operably coupled with the first actuator and the second actuator. The sensor system is configured to generate data indicative of a position of a first rod within the first actuator and a position of a second rod within the second actuator. A control circuit is fluidly coupled with the first actuator and the second actuator. The control circuit includes a fluid control valve configured to restrict a flow of hydraulic fluid in a first position to allow movement of the first actuator and the second actuator and restrict the flow of hydraulic fluid in a second position to allow movement of the first actuator and the second actuator. A computing system is operably coupled with the control circuit and the sensor system. The computing system is configured to determine a first amount of movement experienced by the first actuator within a defined time frame, determine a second amount of movement experienced by the second actuator within the defined time frame, and actuate the fluid control valve between the first position and the second position based at least in part on the first amount of movement or the second amount of movement exceeding a threshold.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a front perspective view of a vehicle in accordance with aspects of the present subject matter;

FIG. 2 illustrates a rear perspective view of the vehicle in accordance with aspects of the present subject matter;

FIG. 3 illustrates a side view of the vehicle in accordance with aspects of the present subject matter;

FIG. 4 illustrates a schematic diagram of a vehicle system in accordance with aspects of the present subject matter;

FIG. 5 illustrates a schematic diagram of components of the vehicle system in accordance with aspects of the present subject matter;

FIGS. 6A-6C illustrate a control circuit operably coupled with an actuator of a boom assembly in accordance with aspects of the present subject matter; and

FIG. 7 illustrates a flow diagram of a method for an operation of a system for a boom assembly in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the defined functionality is achieved, irrespective of architectures or intermedial components. Likewise, any two components so associated can also be viewed as being “operably connected” or “operably coupled” to each other to achieve the defined functionality, and any two components capable of being so associated can also be viewed as being “operably couplable” to each other to achieve the defined functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a system that may include a boom assembly. A first actuator and a second actuator may be operably coupled with the boom assembly and configured to alter a position of the boom assembly. A control circuit may be fluidly coupled with the first actuator and the second actuator. The control circuit may include a fluid control valve configured to restrict a flow of hydraulic fluid in a first position to allow movement of the first actuator and the second actuator and restrict the flow of hydraulic fluid in a second position to allow movement of the first actuator and the second actuator.

In some examples, a sensor system may be operably coupled with the first actuator and the second actuator. The sensor system may be configured to generate data indicative of a position of a first rod within the first actuator and a position of the second rod within the second actuator.

A computing system may be operably coupled with the control circuit and the sensor system. The computing system may be configured to determine a first amount of movement experienced by the first actuator within a defined time frame, determine a second amount of movement experienced by the second actuator within the defined time frame, and actuate the fluid control valve between the first position and the second position based at least in part on the first amount of movement or the second amount of movement exceeding a threshold. In some cases, the first amount of movement may include a length movement of the first actuator within the defined time frame and the second amount of movement may include a length movement of the second actuator within the defined time frame. Additionally or alternatively, the first amount of movement may include a velocity of the first actuator within the defined time frame and a velocity of the second actuator within the defined time frame.

Additionally or alternatively, the computing system may be configured to actuate the fluid control valve between the first position and the second position based at least in part on mode of operation of the boom assembly. In various instances, the defined mode may be an autoboom mode in which one or more actuators adjust a position of the boom assembly, and/or any other mode.

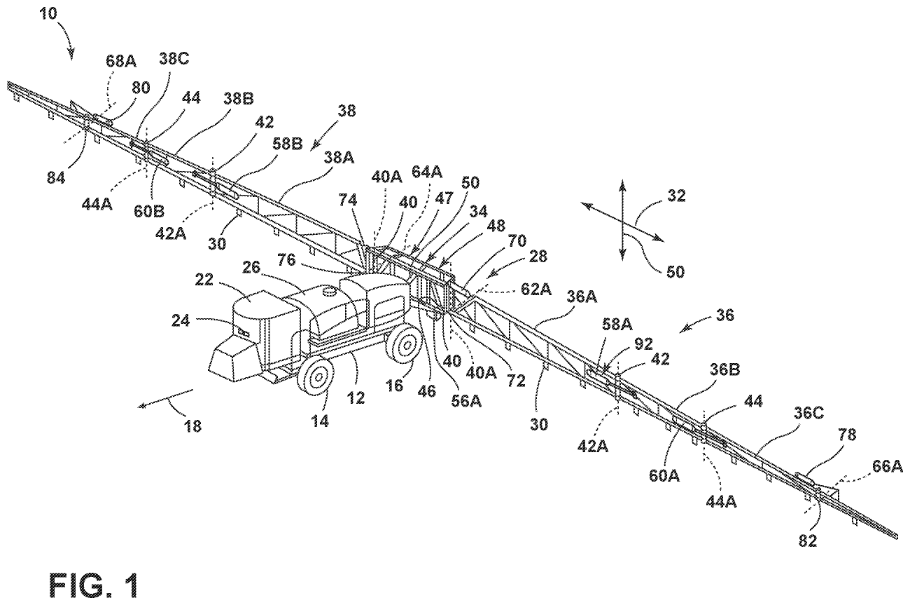

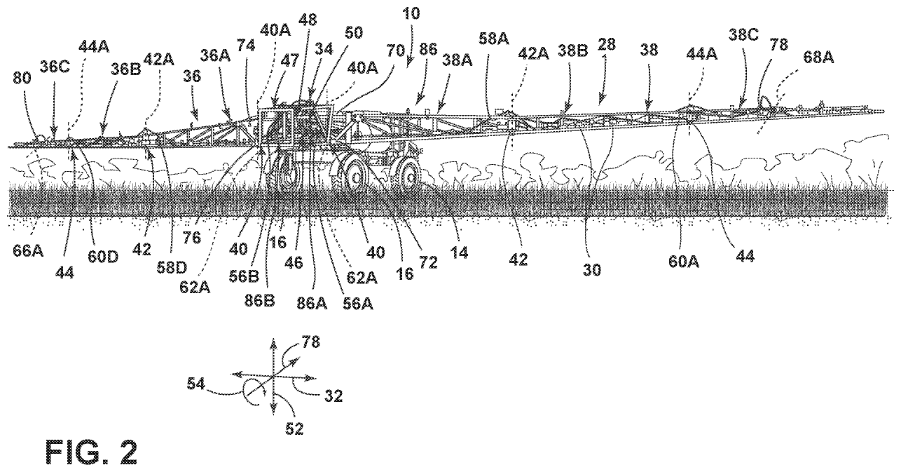

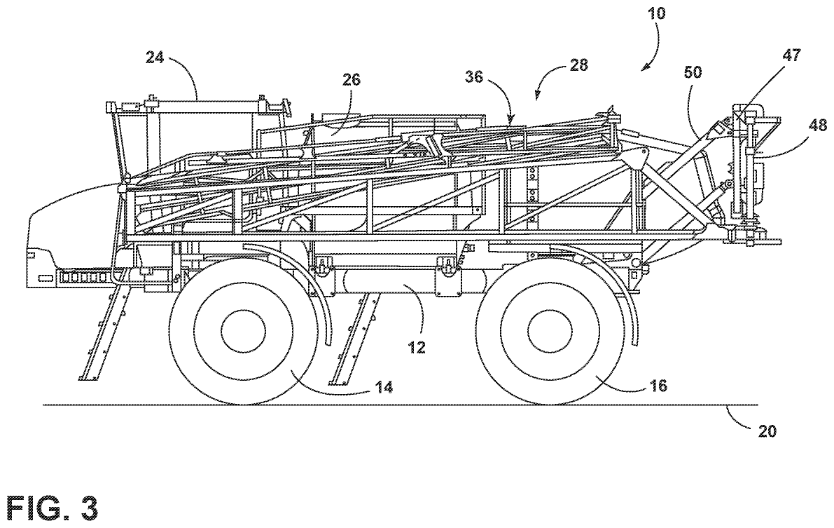

Referring now to FIGS. 1-3, differing views of a vehicle 10 are illustrated in accordance with aspects of the present subject matter. As shown, FIG. 1 illustrates a front perspective view of the vehicle with a boom assembly in a working or unfolded position, FIG. 2 illustrates a rear perspective view of the vehicle with a boom assembly in a working or unfolded position, and FIG. 3 illustrates a side view of the vehicle with a boom assembly in a transport or folded position. In the illustrated examples, the vehicle is configured as a self-propelled vehicle. However, in alternative embodiments, the vehicle may be configured as any other suitable type of vehicle configured to perform agricultural operations, such as a tractor or other vehicle configured to haul any type of implement.

As shown in FIGS. 1 and 2, the vehicle 10 may include a chassis 12 or frame configured to support or couple to a plurality of components. For example, front wheels 14 and rear wheels 16 may be coupled to the chassis 12. The wheels 14, 16 may be configured to support the vehicle 10 relative to the ground 20 and move the vehicle 10 in a direction of travel (e.g., as indicated by arrow 18 in FIG. 1) across the ground 20.

The chassis 12 may also support an operator's cab 22 that houses various control or input devices 104 (e.g., levers, pedals, control panels, buttons, and/or the like) for permitting an operator to control the operation of the vehicle 10. For instance, as shown in FIG. 1, the vehicle 10 may include a human-machine or user interface 24 for displaying message windows and/or alerts to the operator and/or for allowing the operator to interface with the vehicle's controller or computing system.

Furthermore, the chassis 12 may also support one or more tanks 26, which may be in the form of a product tank and/or an auxiliary tank. Each product tank is generally configured to store or hold an agricultural product, such as a pesticide, an herbicide, a nutrient, and/or the like. The auxiliary tank may be configured to store or hold clean water and/or any other product, which may be different from the agricultural product within the product tank.

The chassis 12 may further support a boom assembly 28 operably mounted to the chassis 12. A plurality of nozzle assemblies 30 are mounted on the boom assembly 28 and configured to selectively dispense the agricultural product stored in the one or more tanks 26 via the nozzle assemblies 30 onto underlying plants and/or soil. The nozzle assemblies 30 are generally spaced apart from each other on the boom assembly 28 along a lateral direction 32. Furthermore, fluid conduits may fluidly couple the nozzle assemblies 30 to the one or more tanks 26. Each nozzle assembly 30 may include a nozzle valve and an associated spray tip or spray nozzle. In several embodiments, the operation of each nozzle valve may be individually controlled by an associated controller or computing system such that the valve regulates the flow rate and/or another spray characteristic of the agricultural product through the associated spray nozzle.

As shown in FIGS. 1 and 2, in various embodiments, the boom assembly 28 includes a central boom section 34, a left boom arm 36, and a right boom arm 38. The left boom arm 36 includes a left inner boom section 36A pivotably coupled to the central boom section 34, a left middle boom section 36B pivotably coupled to the left inner boom section 36A, and a left outer boom section 36C pivotably coupled to the left middle boom section 36B. Similarly, the right boom arm 38 includes a right inner boom section 38A pivotably coupled to the central boom section 34, a right middle boom section 38B pivotably coupled to the right inner boom section 38A, and a right outer boom section 38C pivotably coupled to the right middle boom section 38B. Each of the inner boom sections 36A, 38A is pivotably coupled to the central boom section 34 at pivot joints 40. Similarly, the middle boom sections 36B, 38B are pivotally coupled to the respective inner boom sections 36A, 38A at pivot joints 46 while the outer boom sections 36C, 38C are pivotably coupled to the respective middle boom sections 36B, 38B at pivot joints 44.

The pivot joints 40, 42, 44 may be configured to allow relative pivotal motion between adjacent boom sections of the boom assembly 28. For example, the pivot joints 40, 42, 44 may allow for articulation of the various boom sections between a fully extended or working position (e.g., as shown in FIGS. 1 and 2), in which the boom sections are unfolded along the lateral direction 32 to allow for the performance of an agricultural spraying operation, and a transport position (FIG. 3), in which the boom sections are folded inwardly to reduce the overall width of the boom assembly 28 along the lateral direction 32. It will be appreciated that, although the boom assembly 28 is shown in FIGS. 1-3 as including a central boom section 34 and three individual boom sections 34A, 34B, 36A, 36B, 38A, 38B coupled to each side of the central boom section 34, the boom assembly 28 may generally have any suitable number of boom sections. For example, in other embodiments, each boom arm 36, 38 may include four or more boom sections or less than three boom sections.

In some embodiments, the boom assembly 28 may include a mast 47 coupled to a frame 48 that, in combination, can support the boom assembly 28 relative to the chassis 12. For example, the frame 48 can be coupled to the mast 47 via a linkage configured to transfer a downward load of the frame 48 to the mast 47 along axis 52. For instance, the weight of the first and second boom arms 36, 38 is supported by the frame 48, and the frame 48 transfers the load to the mast 47 via the linkage. The mast 47, in turn, transfers the load to the chassis 12 via the linkage assembly, thereby suspending the boom assembly 28 above the ground 20. Furthermore, the linkage may experience rotation of the frame 48 relative to the mast 47 about an axis parallel to the direction of travel 18. For example, if the vehicle 10 tilts to one side due to variations in the terrain, the boom may rotate about the axis, illustrated by rotational line 54.

In various examples, the linkage can include one or more actuators 50 that is configured to rotate the frame 48 relative to the mast 47, which may be performed to counteract the rotation of the boom assembly 28. Additionally or alternatively, the one or more actuators 50 may be configured to adjust the height of the boom assembly 28 relative to the chassis 12 of the vehicle 10 may be adjusted by one or more actuators 50 operably coupled with the boom assembly 28 and the chassis 12. In some instances, the height may be adjusted along an axis, as generally illustrated by line 52 in FIG. 2.

Additionally, as shown in FIGS. 1 and 2, the boom assembly 28 may include inner fold actuators 56A, 56B coupled between the inner boom sections 36A, 38A and the central boom section 34 to enable pivoting or folding between the fully-extended working position and the transport position. For example, by retracting/extending the inner fold actuators 56A, 56B, the inner boom sections 36A, 38A may be pivoted or folded relative to the central boom section 34 about a pivot axis 40A respectively defined by the pivot joints 40. Moreover, the boom assembly 28 may also include middle fold actuators 58A, 58B coupled between each inner boom section 36A, 38A and its adjacent middle boom section 36B, 38B and outer fold actuators 60A, 60B coupled between each middle boom section 36B, 38B and its adjacent outer boom section 36C, 38C. As such, by retracting/extending the middle and outer fold actuators 58A, 58B, 60A, 60B, each middle and outer boom section 36B, 38B, 36C, 38C may be pivoted or folded relative to its respective inwardly adjacent boom section 36A, 38A, 36B, 38B about a respective pivot axis 42A, 44A.

In various examples, the boom assembly 28 may move relative to one or more yaw-related pivot axes. For instance, the boom assembly 28 may rotate relative to a left yaw axis and/or a right yaw axis, either of which may be affected by one or more of the pivot axes 40A, 42A, 46A. In various instances, the fold actuators 56A, 56B, 58A, 58B, 60A, 60B may be adjusted to mitigate the yaw-related movement.

With further reference to FIGS. 1-3, the boom assembly 28 may additionally or alternatively be configured to move various boom sections relative to one another and/or relative to chassis 12 about a relative axis 52, 54, 62A, 64A, 66A, 68A. In the illustrated examples, the boom assembly 28 may be affected by the positions of the various sections relative to one another about the axis 54 for the central boom section 34, the lift axis 52 for the central boom section 34, the left main shoulder pivot axis 62A, the right main shoulder pivot axis 64A, a left tertiary shoulder pivot axis 66A, and/or a right tertiary shoulder pivot axis 68A.

For example, as shown in FIGS. 1 and 2, a tilt actuator 70 may be positioned between the left inner boom section 36A and the central boom section 34. As a result, the tilt actuator 70 can be configured to drive rotation of the left inner boom section 36A relative to the central boom section 34 about the axis 62A. In some instances, a first rotation assembly 72 is mounted between the left inner boom section 36A and the central boom section 34 and defines the axis 62A. As such, the first rotation assembly 72 may be configured to enable rotation of the left inner boom section 36A in response to the actuation of the tilt actuator 70.

In addition, a tilt actuator 74 may be positioned between the right inner boom section 38A and the central boom section 34. As a result, the tilt actuator 74 can be configured to drive rotation of the right inner boom section 38A relative to the central boom section 34 about an axis 64A. In some instances, a second rotation assembly 76 is mounted between the right inner boom section 38A and the central boom section 34 and defines the axis 64A. As such, the second rotation assembly 76 may be configured to enable rotation of the right inner boom section 38A in response to the actuation of the tilt actuator 74.

Further, respective lift actuators 78, 80 may be positioned between each middle boom section 36B, 38B and its adjacent outer boom section 36C, 38C. As a result, the lift actuators 78, 80 can be configured to drive rotation, with respective third and fourth rotation assemblies 82, 84 of each middle boom section 36B, 38B and its adjacent outer boom section 36C, 38C about respective roll axes 66A, 68A. In some instances, third and fourth rotation assemblies 82, 84 can be respectively mounted between each middle boom section 36B, 38B and its adjacent outer boom section 36C, 38C and respectively define the roll axes 66A, 68A. As such, the third and fourth rotation assemblies 82, 84 may be configured to enable rotation of each middle boom section 36B, 38B and its adjacent outer boom section 36C, 38C in response to the actuation of the respective lift actuator 78, 80.

Furthermore, the boom assembly 28 can include one or more roll control actuators 86A, 86B that may operably connect the mast 47 and the frame 48. The one or more roll control actuators may allow for the boom assembly 28 to roll or rotate independent of the mast and/or the linkage assembly.

In various examples, any of the actuators 56A, 56B, 58A, 58B, 60A, 60B, 70, 74, 78, 80, 86A, 86B described herein may be configured as hydraulic cylinders. However, it will be appreciated that different actuators 56A, 56B, 58A, 58B, 60A, 60B, 70, 74, 78, 80, 86A, 86B may be used in other embodiments. For example, any of the actuators 56A, 56B, 58A, 58B, 60A, 60B, 70, 74, 78, 80, 86A, 86B may be configured as electric actuators, pneumatic cylinders, pulley systems, and/or any other practicable device. Moreover, in certain embodiments, the rotation elements 56A, 56B may be configured as hinges. However, in other embodiments, the rotation elements 56A, 56B may include flexible connection members (e.g., expansion joints), cross joints, additional actuators, and/or any other practicable assembly.

With further reference to FIGS. 1-3, the vehicle 10 may also include a sensor system 90. In general, the sensor system 90 may be configured to capture data indicative of one or more operating conditions or parameters associated with the performance and/or operation of the boom assembly 28, a system operably coupled with the vehicle 10, an assembly operably coupled with the vehicle 10, such as the boom assembly 28. The sensor system 90 may include one or more sensors 92, a weather station, and/or any other assembly, which may be installed on the vehicle 10 and/or the boom assembly 28. For instance, in some embodiments, the one or more sensors 92 may be installed on the boom assembly 28 to allow operating parameters/conditions associated with the boom assembly 28 to be monitored. However, in other embodiments, one or more sensors 92 may be installed relative to or in association with any other suitable components, features, systems, and/or sub-systems of the vehicle 10 and/or remotely from the vehicle 10. In various examples, the sensors 92 may include boom position sensors, flow sensors, motion sensors (e.g., accelerometers, gyroscopes, etc.), image sensors (e.g., cameras, LIDAR devices, etc.), radar sensors, ultrasonic sensors, actuator position sensors, and/or any other practicable sensor, depending on the operating conditions being monitored.

In several examples, the sensor system 90 can include a first set of one or more sensors 92 that is configured to detect a height of the boom assembly 28 relative to the ground 20 at a defined location on the boom assembly 28. In some cases, the first set of sensors 92 can include eight (or more or less) sensors 92 spaced apart from one another along the boom assembly 28. Based on the data captured from each of the first set of sensors 92, a ground profile of the boom assembly 28 may be determined.

Additionally or alternatively, the sensor system 90 can include a second set of one or more sensors 92 that are configured to detect a position of the various sections of the boom assembly 28 relative to another. As provided herein, the boom assembly 28 may be affected by the positions of the various sections relative to one another about the axis 54 for the central boom section 34, the lift axis 52 for the central boom section 34, the left main shoulder pivot axis 62A, the left main shoulder pivot axis 64A, a left tertiary shoulder pivot axis 66A, and/or a right tertiary shoulder pivot axis 68A. In some cases, the second set of sensors 92 can be operably coupled with any of the axes 40A, 42A, 46A, 52, 54, 62A, 64A, 66A, 68A and configured to determine a position of the various sections of the boom assembly 28 relative to one another. Based on the data captured from each of the second set of sensors 92, a position profile of the boom assembly 28 may be determined.

Additionally or alternatively, the sensor system 90 can include a third set of one or more sensors 92 that is configured to detect a weight of the boom assembly 28 or sections thereof. In some cases, the third set of sensors 92 can include one or more pressure transducers that can be positioned on the central boom section 34 of the boom assembly 28, and/or operably coupled with the tilt actuator 70, 74 of the first boom arm and/or the second boom arm.

Additionally or alternatively, the sensor system 90 may include one or more actuator position sensors 92 that may be configured to detect a position of a first component of the any of the actuators 56A, 56B, 58A, 58B, 60A, 60B, 70, 74, 78, 80, 86A, 86B relative to a second component of the respective actuator 56A, 56B, 58A, 58B, 60A, 60B, 70, 74, 78, 80, 86A, 86B. For instance, the actuator position sensor 92 may be configured as a capacitive displacement sensor, an eddy-current sensor, a hall effect sensor, an inductive sensor, a laser Doppler vibrometer, a linear variable differential transformer (LVDT), a photodiode array, a piezo-electric transducer (piezo-electric), a position encoder (an absolute encoder, an incremental encoder, a linear encoder, a rotary encoder, etc.), a potentiometer, a proximity sensor, a string potentiometer (also known as a string potentiometer, string encoder, or cable position transducer), an ultrasonic sensor, any other practicable sensor, and/or a combination thereof. In various examples, the actuator position sensor 92 may be formed with the hydraulic cylinder and its piston, but, other types of sensors could be used to measure the first component of the actuator 56A, 56B, 58A, 58B, 60A, 60B, 70, 74, 78, 80, 86A, 86B to the second component of the actuator 56A, 56B, 58A, 58B, 60A, 60B, 70, 74, 78, 80, 86A, 86B. Moreover, sensors 92 that measure voltage changes as a function of the displacement of a cylinder is representative and as such sensors that measure other types of parameters, such as sound, current, force, and the like, may be used and are considered within the scope of the invention.

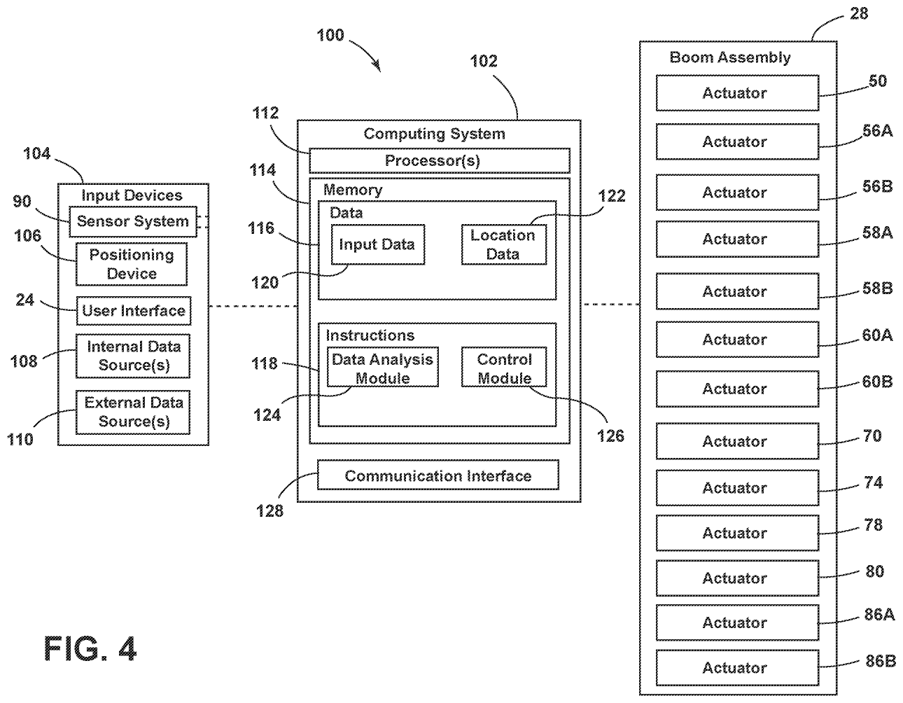

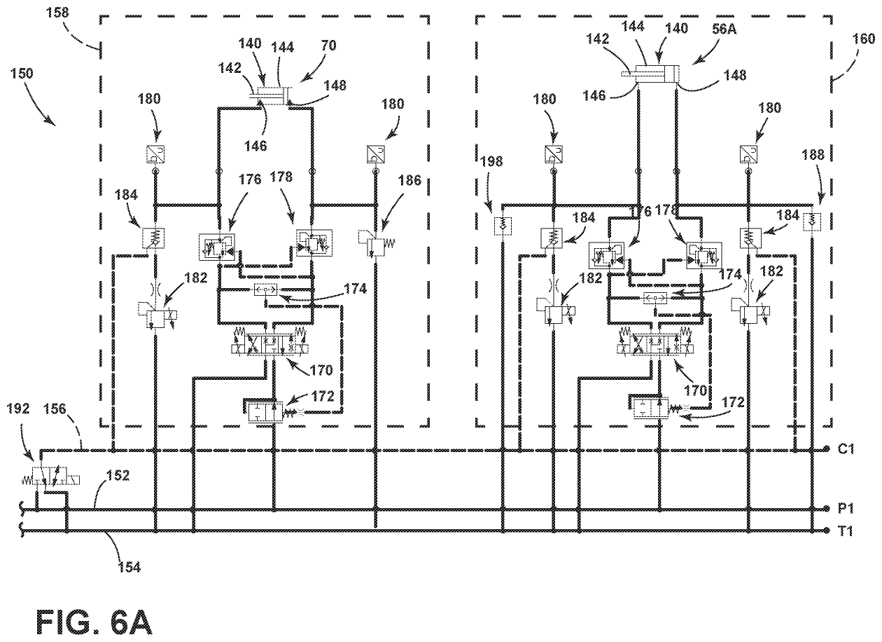

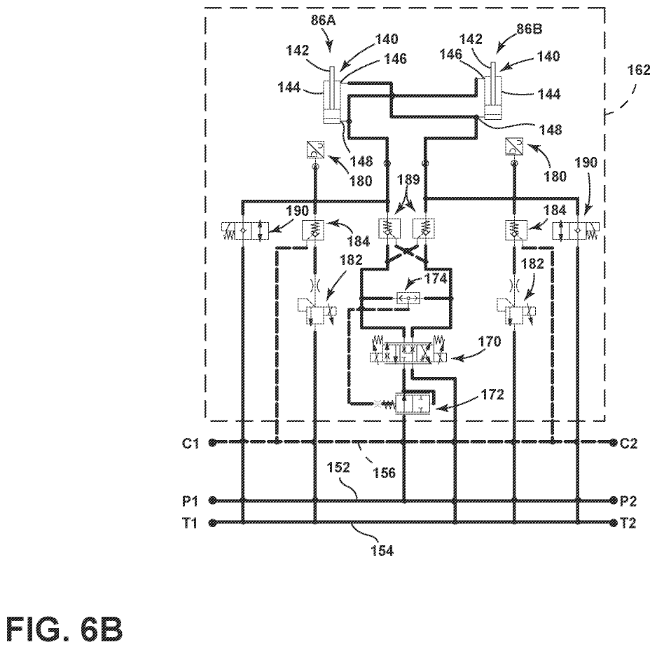

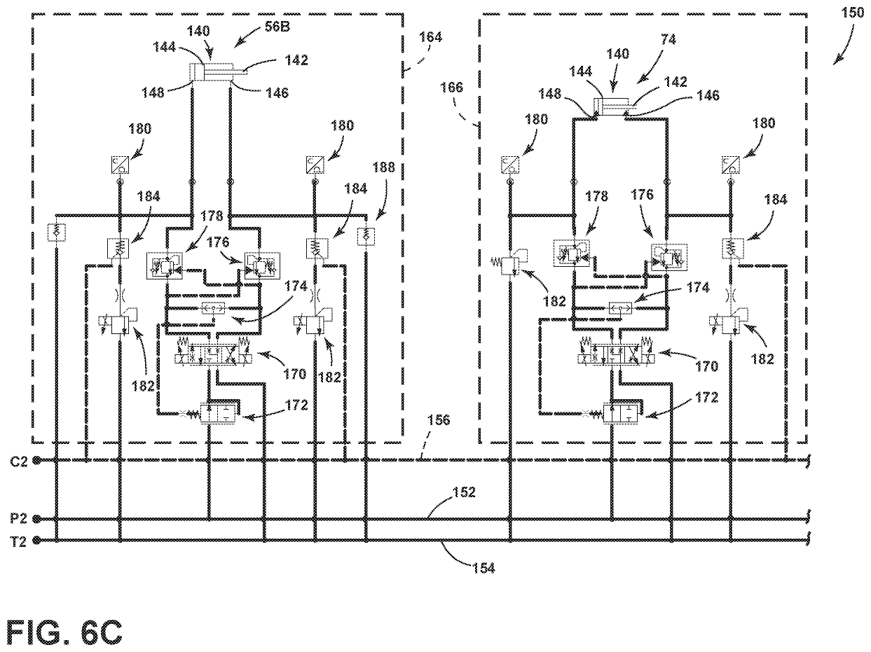

Referring to FIG. 4, when the boom assembly 28 is in the extended position (as illustrated in FIGS. 1 and 2), the position of various sections of the boom assembly 28 may be affected due to the movement of various sections of the boom assembly 28. For instance, the boom assembly 28 may be affected by the positions of the various sections relative to the axis 54 (FIG. 2) for the central boom section 34, the lift axis 52 (FIG. 2) for the central boom section 34, the left main shoulder pivot axis 62A (FIG. 1), the right main shoulder pivot axis 64A (FIG. 1), a left tertiary shoulder pivot axis 66A (FIG. 1), and/or a right tertiary shoulder pivot axis 68A (FIG. 1). As provided herein, movement about each axis may be controlled via an actuator 56A, 56B, 58A, 58B, 60A, 60B, 70, 74, 78, 80, 86A, 86B. In some cases, each actuator 56A, 56B, 58A, 58B, 60A, 60B, 70, 74, 78, 80, 86A, 86B may be a hydraulic cylinder that may be driven via a control circuit 150 (FIGS. 6C-6C). Due to the configuration of the boom assembly 28, the actuation of one actuator 56A, 56B, 58A, 58B, 60A, 60B, 70, 74, 78, 80, 86A, 86B can impact the manner in which one or more of the other actuators 56A, 56B, 58A, 58B, 60A, 60B, 70, 74, 78, 80, 86A, 86B may be controlled to maintain the boom assembly 28 at the defined position relative to the ground 20, which may be based on the ground profile and/or the position profile. As such, the vehicle 10 may include a system 100 that is configured to determine a position (e.g., a stroke length) for each actuator 56A, 56B, 58A, 58B, 60A, 60B, 70, 74, 78, 80, 86A, 86B based on an impact to one or more remaining actuators 56A, 56B, 58A, 58B, 60A, 60B, 70, 74, 78, 80, 86A, 86B to maintain the boom assembly 28 at a defined position relative to the ground 20.

The system 100 may additionally or alternatively be configured to determine an amount of movement experienced by an actuator 56A, 56B, 58A, 58B, 60A, 60B, 70, 74, 78, 80, 86A, 86B within a defined time frame and allow or restrict movement of the actuator 56A, 56B, 58A, 58B, 60A, 60B, 70, 74, 78, 80, 86A, 86B based on the amount of movement. Additionally or alternatively, the system 100 may be configured to allow or restrict movement of the actuator 56A, 56B, 58A, 58B, 60A, 60B, 70, 74, 78, 80, 86A, 86B based at least in part on mode of operation of the boom assembly. In various instances, the defined mode may be an autoboom mode in which one or more actuators adjust a position of the boom assembly, and/or any other mode.

With further reference to FIG. 4, the system 100 will be described with reference to the vehicle 10 described above with reference to FIGS. 1-3. However, it should be appreciated by those of ordinary skill in the art that the disclosed system 100 may generally be utilized with agricultural machines having any other suitable machine configuration.

As shown in FIG. 4, the system 100 can include a computing system 102 operably coupled with input devices 104 and one or more actuators 56A, 56B, 58A, 58B, 60A, 60B, 70, 74, 78, 80, 86A, 86B within the boom assembly 28. In general, the computing system 102 may correspond to any suitable processor-based device(s), such as a computing device or any combination of computing devices. For example, the computing system 102 may generally include one or more processor(s) 112 and associated memory 114 configured to perform a variety of computer-implemented functions (e.g., performing the methods, steps, algorithms, calculations, and the like disclosed herein). As used herein, the term “processor” refers not only to integrated circuits referred to in the art as being included in a computer, but also refers to a controller, a microcontroller, a microcomputer, a programmable logic controller (PLC), an application-specific integrated circuit, and other programmable circuits. Additionally, the memory 114 may generally include memory element(s) including, but not limited to, computer-readable medium (e.g., random access memory (RAM)), computer-readable non-volatile medium (e.g., a flash memory), a floppy disk, a compact disc-read only memory (CD-ROM), a magneto-optical disk (MOD), a digital versatile disc (DVD) and/or other suitable memory elements. Such memory 114 may generally be configured to store information accessible to the processor(s) 112, including data 116 that can be retrieved, manipulated, created, and/or stored by the processor(s) 112 and instructions 118 that can be executed by the processor(s) 112.

In several embodiments, the data 116 may be stored in one or more databases. For example, the memory 114 may include an input database 120 for storing input data received from the input device(s). For example, the input device(s) may include the sensor system 90, which includes one or more sensors 92 configured to monitor one or more conditions associated with the vehicle 10 and/or the operation being performed therewith (e.g., including one or more of the various sensors 92, described above), one or more positioning device(s) 106 for generating position data associated with the location of the vehicle 10, one or more user interfaces 24 for allowing operator inputs to be provided to the computing system 102 (e.g., buttons, knobs, dials, levers, joysticks, touch screens, and/or the like), one or more other internal data sources 108 associated with the vehicle 10 (e.g., other devices, databases, etc.), one or more external data sources 110 (e.g., a remote computing device or server), and/or any other suitable input device(s). The data received from the input device(s) may, for example, be stored within the input database 120 for subsequent processing and/or analysis. It will be appreciated that, in addition to being considered an input device(s) that allows an operator to provide inputs to the computing system 102, the user interface 24 may also function as an output device. For example, the user interface 24 may be configured to allow the computing system 102 to provide feedback to the operator (e.g., visual feedback via a display or other presentation device, audio feedback via a speaker or other audio output device, and/or the like).

Moreover, in several embodiments, the memory 114 may also include a location database 122 storing location information about the vehicle 10 and/or information about the ground 20 being processed (e.g., a field map). Such location database 122 may, for example, correspond to a separate database or may form part of the input database 120. As shown in FIG. 4, the computing system 102 may be communicatively coupled to the positioning device(s) 106 installed on or within the vehicle 10. For example, in some embodiments, the positioning device(s) 106 may be configured to determine the location of the vehicle 10 using a satellite navigation position system (e.g., a GPS, a Galileo positioning system, the Global Navigation satellite system (GLONASS), the BeiDou Satellite Navigation and Positioning system, and/or the like). In such an embodiment, the location determined by the positioning device(s) 106 may be transmitted to the computing system 102 (e.g., in the form of coordinates) and subsequently stored within the location database 122 for subsequent processing and/or analysis.

Additionally, in several embodiments, the location data stored within the location database 122 may also be correlated to all or a portion of the input data stored within the input database 120. For instance, in some embodiments, the location coordinates derived from the positioning device(s) 106 and the data received from the input device(s) may both be time-stamped. In such an example, the time-stamped data may allow the data received from the input device(s) to be matched or correlated to a corresponding set of location coordinates received from the positioning device(s) 106, thereby allowing the precise location of the portion of the ground 20 associated with the input data to be known (or at least capable of calculation) by the computing system 102.

Moreover, by matching the input data to a corresponding set of location coordinates, the computing system 102 may also be configured to generate or update a corresponding field map associated with the ground 20 being processed. For example, in instances in which the computing system 102 already includes a field map stored within its memory 114 that includes location coordinates associated with various points across the ground 20, the input data received from the input device(s) may be mapped or correlated to a given location within the field map. Alternatively, based on the location data and the associated image data, the computing system 102 may be configured to generate a field map for the ground 20 that includes the geo-located input data associated therewith.

Referring still to FIG. 4, in several embodiments, the instructions 118 stored within the memory 114 of the computing system 102 may be executed by the processor(s) 112 to implement a data analysis module 124. In general, the data analysis module 124 may be configured to analyze the input data (e.g., a set of input data received at a given time or within a given time period or a subset of the data, which may be determined through a pre-processing method) to determine the current one or more operating parameters or conditions of the boom assembly 28 using any algorithm and/or data processing technique. In various examples, the data analysis module 124 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 102 and may be used to generate subsequent instructions.

In some examples, the data analysis module 124 may receive the input data from input devices 104. In turn, the system 100 may determine a current boom profile based on boom position data and defined boom dimensions/a defined boom geometry. Additionally, the system 100 may determine relative positions at various locations along the boom assembly 28 based on boom height data. In some examples, the system 100 may further calculate a ground profile based on the boom height data. The system 100 may further determine a target boom profile based on the current ground profile. Further, the system 100 may calculate a defined position for one or more actuators 56A, 56B, 58A, 58B, 60A, 60B, 70, 74, 78, 80, 86A, 86B of the boom assembly 28 (e.g., a stroke length for each cylinder) to achieve the defined boom profile. In some instances, the defined position for one or more of the actuators 56A, 56B, 58A, 58B, 60A, 60B, 70, 74, 78, 80, 86A, 86B of the boom assembly 28 may be based at least partially on an effect of movement of a first actuator of the one or more actuators 56A, 56B, 58A, 58B, 60A, 60B, 70, 74, 78, 80, 86A, 86B on a second actuator of the one or more actuators 56A, 56B, 58A, 58B, 60A, 60B, 70, 74, 78, 80, 86A, 86B (or the remaining actuators of the one or more actuators) to maintain the boom assembly 28 at the defined position relative to the ground 20.

Additionally or alternatively, the data analysis module 124 may receive the input data from input devices 104. In turn, the system 100 may determine whether the boom assembly is operating a defined mode (e.g., an auto boom mode).

Referring still to FIG. 4, the instructions 118 stored within the memory 114 of the computing system 102 may also be executed by the processor(s) 112 to implement a control module 126. In general, the control module 126 may be configured to adjust the operation of the boom assembly 28 by controlling one or more components of the vehicle 10. In several embodiments, the control module 126 may be configured to control the boom assembly 28 through one or more valves within a hydraulic circuit. By controlling the one or more valves, each actuator 56A, 56B, 58A, 58B, 60A, 60B, 70, 74, 78, 80, 86A, 86B may be controlled and/or placed in a defined position. In some examples, if the boom assembly 28 is not operating in the defined mode, the control module 126 may lock one or more pressure control valves out from the hydraulic circuit, which may eliminate at least some hydraulic fluid leakage past one or more valves of the hydraulic circuit and/or lock hydraulic fluid between one or more load holding valves and the actuator 56A, 56B, 58A, 58B, 60A, 60B, 70, 74, 78, 80, 86A, 86B. Such control may remove drift of the actuator 56A, 56B, 58A, 58B, 60A, 60B, 70, 74, 78, 80, 86A, 86B and pressure loss within the actuator 56A, 56B, 58A, 58B, 60A, 60B, 70, 74, 78, 80, 86A, 86B during transport. Conversely, when the boom assembly is operated in a defined mode, the control module 126 may alter the work port pressures for any of the actuators 56A, 56B, 58A, 58B, 60A, 60B, 70, 74, 78, 80, 86A, 86B. Such control may reduce the overall stress seen by the boom assembly 28. However, if the boom assembly experiences rapid movements exceeding a defined threshold, the control module 126 may lock out the pressure control valves of the hydraulic circuit. In some cases, the data analysis module 124 may utilize data from one or more actuator position sensors 92 to determine an length movement of the actuator 56A, 56B, 58A, 58B, 60A, 60B, 70, 74, 78, 80, 86A, 86B and/or a velocity of the actuator 56A, 56B, 58A, 58B, 60A, 60B, 70, 74, 78, 80, 86A, 86B. As such, the control module 126 may control one or more valves associated with the actuators 56A, 56B, 58A, 58B, 60A, 60B, 70, 74, 78, 80, 86A, 86B depending on how well the boom assembly is holding a target position.

In several embodiments, the computing system 102 may also automatically control the operation of the user interface 24 to provide an operator notification associated with the determined one or more operating parameters or conditions of the boom assembly 28. For instance, in some embodiments, the computing system 102 may control the operation of the user interface 24 in a manner that causes data associated with the determined one or more operating parameters or conditions of the boom assembly 28 to be presented to the operator of the vehicle 10, such as by presenting raw or processed data associated with the one or more operating parameters or conditions of the boom assembly 28 including numerical values, graphs, maps, and/or any other suitable visual indicators.

Moreover, as shown in FIG. 4, the computing system 102 may also include a communications interface 128 to communicate with any of the various other system components described herein. For instance, one or more communicative links or interfaces (e.g., one or more data buses and/or wireless connections) may be provided between the communications interface 128 and the input device(s) to allow data transmitted from the input device(s) to be received by the computing system 102. Additionally, as shown in FIG. 4, one or more communicative links or interfaces (e.g., one or more data buses and/or wireless connections) may be provided between the communications interface 128 and the actuators 56A, 56B, 58A, 58B, 60A, 60B, 70, 74, 78, 80, 86A, 86B to allow the computing system 102 to control the operation of such system components.

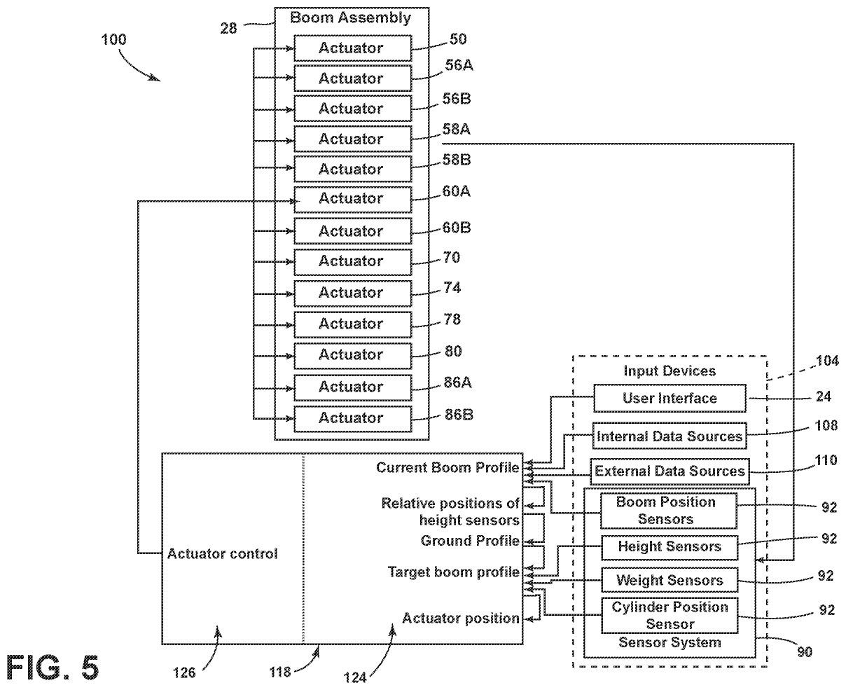

Referring to FIGS. 5-6C, various components of the system 100 are illustrated in accordance with various aspects of the present disclosure. Specifically, FIG. 5 illustrates a schematic diagram of components of the vehicle system in accordance with aspects of the present subject matter, FIG. 6A illustrates a first portion of a control circuit, FIG. 6B illustrates a second portion of the control circuit, and FIG. 6C illustrates a third portion of the control circuit. In the example control circuit on FIGS. 6A-6C, it will be appreciated that points C1 in FIGS. 6A and 6B are fluidly coupled to form a common fluid line, points P1 in FIGS. 6A and 6B are fluidly coupled to form a common fluid line, and points T1 in FIGS. 6A and 6B are fluidly coupled to form a common fluid line. Similarly, points C2 in FIGS. 6B and 6C are fluidly coupled to form a common fluid line, points P2 in FIGS. 6B and 6C are fluidly coupled to form a common fluid line, and points T2 in FIGS. 6B and 6C are fluidly coupled to form a common fluid line.

In various examples, the data analysis module 124 may receive data from various components of the system 100, such as via one or more sensors 92, and, in turn, the control module 126 can alter or manipulate the various components, such as one or more valves within a hydraulic circuit operably coupled with one or more of the actuators 56A, 56B, 58A, 58B, 60A, 60B, 70, 74, 78, 80, 86A, 86B of the boom assembly 28 and/or the actuators 56A, 56B, 58A, 58B, 60A, 60B, 70, 74, 78, 80, 86A, 86B of the boom assembly 28 (through manipulation of the one or more valves within the hydraulic circuit and/or through any other method). In some cases, the data analysis module 124 can receive input data from input devices 104 and determine whether the boom assembly 28 is being operating in a defined mode.

In addition, the data analysis module 124 may receive the input data from input devices 104. In turn, the system 100 may determine a current boom profile based on boom position data, which may be provided by the position sensors 88 and/or any other source, and defined boom dimensions/a defined boom geometry, which may be received through the input devices 104. Additionally, the system 100 may determine relative positions at various locations along the boom assembly 28 based on boom height data, which may be provided by one or more height sensors 88. In some examples, the system 100 may further calculate a ground profile based on the boom height data. In such instances, the system 100 may project respective lengths from each height sensor to the ground 20 based on the current boom profile.

The system 100 may further determine a target boom profile based on the current ground profile. In various examples, the target boom profile can be based at least partially on a fixed height target and/or a variable height target that provides for a variable height along a defined boom section. In some cases, the variable height target may account for the boom geometry and other constraints and, in turn, determine a target boom profile that places the boom assembly 28 as close as possible to a target height, which may be a minimum defined height between the nozzles along the boom assembly 28 and a target, such as the ground 20.

Further, the system 100 may calculate a defined position for one or more actuators 56A, 56B, 58A, 58B, 60A, 60B, 70, 74, 78, 80, 86A, 86B of the boom assembly 28 (e.g., a stroke length for each cylinder) to achieve the defined boom profile. In some instances, the defined position for one or more of the actuators 56A, 56B, 58A, 58B, 60A, 60B, 70, 74, 78, 80, 86A, 86B of the boom assembly 28 may be based at least partially on an effect of movement of a first actuator of the one or more actuators 56A, 56B, 58A, 58B, 60A, 60B, 70, 74, 78, 80, 86A, 86B on a second actuator of the one or more actuators 56A, 56B, 58A, 58B, 60A, 60B, 70, 74, 78, 80, 86A, 86B (or the remaining actuators of the one or more actuators) to maintain the boom assembly 28 at the defined boom profile.

Additionally or alternatively, the data analysis module 124 may be configured to determine an amount of movement experienced by an actuator 56A, 56B, 58A, 58B, 60A, 60B, 70, 74, 78, 80, 86A, 86B within a defined time frame. Additionally or alternatively, the data analysis module 124 may be configured to determine whether the vehicle 10 is in a defined mode of operation. In various instances, the defined mode may be an autoboom mode in which one or more actuators 56A, 56B, 58A, 58B, 60A, 60B, 70, 74, 78, 80, 86A, 86B adjust a position of the boom assembly 28, and/or any other mode.

Referring further to FIG. 5, the control module 126 may be configured to adjust the operation of the boom assembly 28 by controlling one or more components of the vehicle 10. In several embodiments, when the boom assembly is operated in the defined mode, the control module 126 may be configured to control the boom assembly 28 by transmitting respective control commands to one or more valves within a hydraulic circuit operably coupled with one or more of the actuators 56A, 56B, 58A, 58B, 60A, 60B, 70, 74, 78, 80, 86A, 86B of the boom assembly 28 and/or the actuators 56A, 56B, 58A, 58B, 60A, 60B, 70, 74, 78, 80, 86A, 86B of the boom assembly 28 (through manipulation of the one or more valves within the hydraulic circuit and/or through any other method).

In turn, data may be collected by the sensor system 90, which may be provided as subsequent inputs to the data analysis module so that additional alterations to one or more actuators 56A, 56B, 58A, 58B, 60A, 60B, 70, 74, 78, 80, 86A, 86B may be made, if needed. In addition, the data analysis module may alter one or more subsequent outputs based on a result of a previous instruction. As such, the data analysis module may learn from the results of previous instructions to alter subsequent instructions.

In some examples, if the boom assembly 28 is not operating in the defined mode, the control module 126 may lock one or more valves out from the hydraulic circuit. Conversely, when the boom assembly is operated in a defined mode, the control module 126 may alter a port pressures for any of the actuators 56A, 56B, 58A, 58B, 60A, 60B, 70, 74, 78, 80, 86A, 86B. Such control may reduce the overall stress seen by the boom assembly 28.

In operation, if the boom assembly 28 experiences rapid movements exceeding a defined threshold (or a length of movement that exceeds a defined threshold, etc.), the control module 126 may lock one or more valves of the hydraulic circuit. In some cases, the data analysis module 124 may utilize data from one or more actuator position sensors 92 to determine an length movement of the actuator 56A, 56B, 58A, 58B, 60A, 60B, 70, 74, 78, 80, 86A, 86B and/or a velocity of the actuator 56A, 56B, 58A, 58B, 60A, 60B, 70, 74, 78, 80, 86A, 86B.

With further reference to FIGS. 6A-6C, one or more actuators may be operably coupled with the central boom section 34, such as one or more tilt actuators 70, 74, one or more inner fold actuators 56A, 56B, and/or one or more roll actuators 86A, 86B. In some examples, each actuator (cylinders 140 in FIGS. 6A-6C is representative of any one of actuators 56A, 56B, 70, 74, 86A, 86B) can be configured as a hydraulically-controlled cylinder. The cylinder 140 may be a single or dual-action cylinder that is responsive to a fluid in a reservoir, such as an oil (hydraulic) or gas (pneumatic). The cylinder 140 can include a piston rod 142 configured to extend and retract with respect to a base housing 144. The cylinder 140 can include a rod port 146 and a base port 148. Fluid from a control circuit 150 fluidly coupled with a reservoir entering the base port 148 (and exiting the rod port 146) causes the piston rod 142 to extend, and fluid from the reservoir entering the rod port 146 (and exiting the base port 148) causes the piston rod 142 to retract. Any of the actuatable valves described herein may be operably coupled with the computing system 102 for movement between positions. Additionally or alternatively, any of the actuable valves may be moved from one position to another position through any other method without departing from the teachings provided herein.

In various examples, the control circuit 150 can include a pressure line 152, a tank line 154, and/or a pilot line 156. As illustrated, the control circuit can include a first tilt actuator circuit 158 configured to actuate the first tilt actuator 70, a first fold actuator circuit 160 configured to actuate the first fold actuator 56A, a roll actuator circuit 162 configured to actuate the first roll actuator 86A and the second roll actuator 86B, a second fold actuator circuit 164 configured to actuate the second fold actuator 56B, and/or a second tilt actuator circuit 166 configured to actuate the second tilt actuator 74. Each of the first tilt actuator circuit 158, the first fold actuator circuit 160, the roll actuator circuit 162, the second fold actuator circuit 164, and the second tilt actuator circuit 166 may be fluidly coupled with the pressure line 152, the tank line 154, and/or the pilot line 156.

In the example illustrated in FIG. 6A, the first tilt actuator circuit 158 may include a directional control valve 170 that controls the retraction/extension of the first tilt actuator 70. In addition, the first tilt actuator circuit 158 can also include a flow valve 172 that may be fluidly coupled with a pressure line 152. The directional control valve 170 may be downstream of the flow valve 172 and may be further fluidly coupled with the tank line 154. As illustrated, a shuttle valve 174 may be downstream of the directional control valve 170. A pair of counterbalance valves 176, 178 may be respectively coupled with the rod port 146 and the base port 148 of the cylinder 140.

The first tilt actuator circuit 158 may further include a first pressure sensor 180, a first proportional pressure relief valve 182, and a first pilot-operated check valve 184 fluidly coupled with the rod port 146 of the cylinder 140.

When there is low pilot pressure, the pilot operated pilot-operated check valve 184 may remain closed, acting as a standard poppet check valve. When the pilot pressure is higher than a spring value, the pilot operated pilot-operated check valve 184 allows a flow of hydraulic fluid in both directions. Accordingly, the pilot operated check valve 184 may be configured to connect and disconnect the ports 146, 148 of the cylinder 140 to the proportional pressure control valves 176, 178.

Additionally, the first tilt actuator circuit 158 may further include a second pressure sensor 180 and a second pressure relief valve 186 in parallel. In various examples, the first proportional pressure relief valve 182 and/or the second proportional pressure relief valve 182 may be configured as inverse proportional relief valves. As such, when the system moves into a “pressure control state,” the first proportional pressure relief valve 182 and/or the second proportional pressure relief valve 182 are connected to the ports 146, 148 of the cylinder 140. Moreover, in some cases, the first pressure relief valve 182 and/or the second pressure relief valve 182 can be electronically-controlled to adjust the relief pressure associated with the first proportional pressure relief valve 182 and/or the second proportional pressure relief valve 182, which may be based, at least in part, on data provided from the input devices 104. In various examples, the relief pressure may be increased as the cylinder stroke varies from a zero or current position (e.g., mid-stroke).

In the example illustrated in FIG. 6A, the first fold actuator circuit 160 may include a directional control valve 170 that controls the retraction/extension of the first fold actuator 56A. In addition, the first fold actuator circuit 160 can also include a flow valve 172 that may be fluidly coupled with a pressure line 152. The directional control valve 170 may be downstream of the flow valve 172 and may be further fluidly coupled with the tank line 154. As illustrated, a shuttle valve 174 may be downstream of the directional control valve 170. A pair of counterbalance valves 176, 178 may be respectively coupled with the rod port 146 and the base port 148 of the cylinder 140.

The first fold actuator circuit 160 may further include a first pressure sensor 180, a first proportional pressure relief valve 182, and a first pilot-operated check valve 184 fluidly coupled with the rod port 146 of the cylinder 140. A check valve 188 may be in parallel with the first pilot-operated check valve 184. Additionally, the first tilt actuator circuit 158 may further include a second pressure sensor 180, a second proportional pressure relief valve 182, and a second pilot-operated check valve 184 fluidly coupled with the base port 148 of the cylinder 140. A check valve 188 may be in parallel with the first pilot-operated check valve 184. As provided herein, when there is low pilot pressure, the pilot operated pilot-operated check valve 184 may remain closed, acting as a standard poppet check valve. When the pilot pressure is higher than a spring value, the pilot operated pilot-operated check valve 184 allows a flow of hydraulic fluid in both directions. Accordingly, the pilot operated check valve 184 may be configured to connect and disconnect the ports 146, 148 of the cylinder 140 to the proportional pressure control valves 176, 178.

In various examples, the first proportional pressure relief valve 182 and/or the second proportional pressure relief valve 182 may be configured as inverse proportional relief valves. As such, when the system moves into a “pressure control state,” the first proportional pressure relief valve 182 and/or the second proportional pressure relief valve 182 are connected to the ports 146, 148 of the cylinder 140. Moreover, in some cases, the first pressure relief valve 182 and/or the second pressure relief valve 182 can be electronically-controlled to adjust the relief pressure associated with the first proportional pressure relief valve 182 and/or the second proportional pressure relief valve 182, which may be based, at least in part, on data provided from the input devices 104. In various examples, the relief pressure may be increased as the cylinder stroke varies from a zero or current position (e.g., mid-stroke).

With further reference to FIG. 6B, the roll actuator circuit 162 may include a directional control valve 170 that controls the retraction/extension of the first roll actuator 86A and/or the second roll actuator 86B. As illustrated, the roll actuator circuit 162 can also include a flow valve 172 that may be fluidly coupled with a pressure line 152. The directional control valve 170 may be downstream of the flow valve 172 and may be further fluidly coupled with the tank line 154. As illustrated, a shuttle valve 174 may be downstream of the directional control valve 170. A pair of pilot operated check valves 184 are positioned downstream of the shuttle valve 174.

The roll actuator circuit 162 may further include a first pressure sensor 180, a first proportional pressure relief valve 182, and a first pilot-operated check valve 184 fluidly coupled with the base port 148 of the cylinder 140 of the first roll actuator 86A and the rod port 146 of the cylinder 140 of the second roll actuator 86B. A solenoid valve 190 may be in parallel with the first pilot-operated check valve 184. Additionally, the roll actuator circuit 162 may further include a second pressure sensor 180, a second proportional pressure relief valve 182, and a second pilot-operated check valve 184 fluidly coupled with the base port 148 of the cylinder 140 of the second roll actuator 86B and the rod port 146 of the cylinder 140 of the first roll actuator 86A. A solenoid valve 190 may be in parallel with the second pilot-operated check valve 184. As provided herein, when there is low pilot pressure, the pilot operated pilot-operated check valve 184 may remain closed, acting as a standard poppet check valve. When the pilot pressure is higher than a spring value, the pilot operated pilot-operated check valve 184 allows a flow of hydraulic fluid in both directions. Accordingly, the pilot operated check valves 184 may be configured to connect and disconnect the ports 146, 148 of the cylinders 140 to the solenoid valves 190.

In various examples, the first proportional pressure relief valve 182 and/or the second proportional pressure relief valve 182 may be configured as inverse proportional relief valves. As such, when the system moves into a “pressure control state,” the first proportional pressure relief valve 182 and/or the second proportional pressure relief valve 182 are connected to the cylinders of the first roll actuator 86A and the second roll actuator 86B. Moreover, in some cases, the first pressure relief valve 182 and/or the second pressure relief valve 182 can be electronically-controlled to adjust the relief pressure associated with the first proportional pressure relief valve 182 and/or the second proportional pressure relief valve 182, which may be based, at least in part, on data provided from the input devices 104. In various examples, the relief pressure may be increased as the cylinder stroke varies from a zero or current position (e.g., mid-stroke).

In some examples, the flow valve may be configured as a pressure control solenoid valve. In such examples, the pressure control solenoid valve may be a 3-way 2-position solenoid valve. When the pressure control solenoid valve is in its non-energized state, the pressure control solenoid valve may vent all of the pilot lines 156 to a tank fluidly coupled with the tank line 154. When there is low pressure in the pilot lines 156, the poppet valves stay closed. When the system moves into the pressure control state, the pressure control solenoid valve is placed in its energized state. In such instances, the pressure control solenoid valve connects all of the pilot lines 156 to an auxiliary pump pressure. In various instances, the auxiliary pump pressure is high enough to open up all of the piloted poppet valves. In addition, in the energized state, the cylinder work ports 146, 148 of each cylinder 140 are operably coupled to their respective proportional control valves.

Referring further to FIG. 6C, the second fold actuator circuit 164 may include a directional control valve 170 that controls the retraction/extension of the second fold actuator 56B. In addition, the second fold actuator circuit 164 can also include a flow valve 172 that may be fluidly coupled with a pressure line 152. The directional control valve 170 may be downstream of the flow valve 172 and may be further fluidly coupled with the tank line 154. As illustrated, a shuttle valve 174 may be downstream of the directional control valve 170. A pair of counterbalance valves 176, 178 may be respectively coupled with the rod port 146 and the base port 148 of the cylinder 140.

The second fold actuator circuit 164 may further include a first pressure sensor 180, a first proportional pressure relief valve 182, and a first pilot-operated check valve 184 fluidly coupled with the rod port 146 of the cylinder 140. A check valve 188 may be in parallel with the first pilot-operated check valve 184. Additionally, the second fold actuator circuit 164 may further include a second pressure sensor 180, a second proportional pressure relief valve 182, and a second pilot-operated check valve 184 fluidly coupled with the base port 148 of the cylinder 140. A check valve 188 may be in parallel with the first pilot-operated check valve 184. As provided herein, when there is low pilot pressure, the pilot operated pilot-operated check valves 184 may remain closed, acting as a standard poppet check valve. When the pilot pressure is higher than a spring value, the pilot operated pilot-operated check valves 184 allow a flow of hydraulic fluid in both directions. Accordingly, the pilot operated check valves 184 may be configured to connect and disconnect the ports 146, 148 of the cylinder 140 to the proportional pressure control valves 176, 178.

In various examples, the first proportional pressure relief valve 182 and/or the second proportional pressure relief valve 182 may be configured as inverse proportional relief valves. As such, when the system moves into a “pressure control state,” the first proportional pressure relief valve 182 and/or the second proportional pressure relief valve 182 are connected to the ports 146, 148 of the cylinder 140. Moreover, in some cases, the first pressure relief valve 182 and/or the second pressure relief valve 182 can be electronically-controlled to adjust the relief pressure associated with the first proportional pressure relief valve 182 and/or the second proportional pressure relief valve 182, which may be based, at least in part, on data provided from the input devices 104. In various examples, the relief pressure may be increased as the cylinder stroke varies from a zero or current position (e.g., mid-stroke).

Referring further to FIG. 6C, the second tilt actuator circuit 166 may include a directional control valve 170 that controls the retraction/extension of the second tilt actuator 74. In addition, the second tilt actuator circuit 166 can also include a flow valve 172 that may be fluidly coupled with a pressure line 152. The directional control valve 170 may be downstream of the flow valve 172 and may be further fluidly coupled with the tank line 154. As illustrated, a shuttle valve 174 may be downstream of the directional control valve 170. A pair of counterbalance valves 176, 178 may be respectively coupled with the rod port 146 and the base port 148 of the cylinder 140.

The second tilt actuator circuit 166 may further include a first pressure sensor 180, a first proportional pressure relief valve 182, and a first pilot-operated check valve 184 fluidly coupled with the rod port 146 of the cylinder 140. The first pilot-operated check valve 184 may be configured as pilot operated check valves. As such, when there is low pilot pressure, the pilot operated pilot-operated check valve 184 may remain closed, acting as a standard poppet check valve. When the pilot pressure is higher than a spring value, the pilot operated pilot-operated check valve 184 allows a flow of hydraulic fluid in both directions. Accordingly, the pilot operated check valve 184 may be configured to connect and disconnect the ports 146, 148 of the cylinder 140 to the proportional pressure control valves 176, 178.

Additionally, the second tilt actuator circuit 166 may further include a second pressure sensor 180 and a second pressure relief valve 186 fluidly coupled with the base port 148 of the cylinder 140. In various examples, the first proportional pressure relief valve 182 and/or the second proportional pressure relief valve 182 may be configured as inverse proportional relief valves. As such, when the system moves into a “pressure control state,” the first proportional pressure relief valve 182 and/or the second proportional pressure relief valve 182 are connected to the ports 146, 148 of the cylinder 140. Moreover, in some cases, the first pressure relief valve 182 and/or the second pressure relief valve 182 can be electronically-controlled to adjust the relief pressure associated with the first proportional pressure relief valve 182 and/or the second proportional pressure relief valve 182, which may be based, at least in part, on data provided from the input devices 104. In various examples, the relief pressure may be increased as the cylinder stroke varies from a zero or current position (e.g., mid-stroke).

Referring further to FIGS. 6A-6C, a fluid control valve 192 may be coupled upstream of each or all of the first tilt actuator circuit, the first fold actuator circuit 160, the roll actuator circuit 162, the second fold actuator circuit 164, and/or the second tilt actuator circuit 166. In various examples, the fluid control valve 192 may be configured as a three-way, two-position solenoid valve. In such instances, when the fluid control valve 192 is in a non-energized state, the valve may venting all of the pilot lines 156 to a tank fluidly coupled with the tank line 154. When there is low pressure in the pilot lines 156, the pilot-operated check valves 184 may remain closed. When the control vale is moved into an energized state, the fluid control valve 192 may connect any or all of the pilot-operated check valves 184 to a pump pressure via the pressure line 152. In such instances, the pump pressure may be high enough to open up any or all of the pilot-operated check valves 184, and connects the ports 146, 148 of each cylinder 140 to any associated proportional pressure control valves 176, 178.

In operation, the position of various sections of the boom assembly 28 may be affected due to the movement of the boom assembly relative to various axes 40A, 42A, 46A, 52, 54, 62A, 64A, 66A, 68A, external forces, and/or for any other reason. Moreover, the actuation of one actuator 56A, 56B, 58A, 58B, 60A, 60B, 70, 74, 78, 80, 86A, 86B may impact the manner in which one or more of the other actuators 56A, 56B, 58A, 58B, 60A, 60B, 70, 74, 78, 80, 86A, 86B may be controlled to maintain the boom assembly 28 at the defined position relative to the ground 20 and/or at the defined home position relative to the chassis 12. Additionally or alternatively, in various instances, each actuator 56A, 56B, 58A, 58B, 60A, 60B, 70, 74, 78, 80, 86A, 86B may be configured to dampen the movement of the boom sections (e.g., in the fore-aft direction and/or in the vertical direction) and to allow the cylinder to absorb energy as opposed to the structure of the boom assembly 28.

In some cases, however, a large amount of boom movement may be experienced by the boom assembly during various operations, such as when the vehicle 10 traverses a rugged topography. In addition, by using proportional pressure controls to control movement of the boom assembly 28, an overall hydraulic fluid leakage past the valving may occur, which may cause hydraulic actuators to drift over time, due to the lost hydraulic fluid past these pressure control valves 176, 178. As such, the control circuit 150 provided herein may be capable of disconnecting one or more pressure control valves 176, 178 from an associated cylinder 140 via the pilot-operated check valves 184. The control circuit 150 provided herein, with such capabilities, allows for the ability to lock one or more pressure control valves 176, 178 out from the circuit when the boom assembly 28 is not operated in a defined mode (e.g. auto boom mode), which may eliminate at least some hydraulic fluid leakage past the one or more pressure control valves 176, 178, and may lock hydraulic fluid between the load holding valves and the associated cylinder 140 to remove cylinder drift and pressure loss during transport of the boom assembly 28. Additionally or alternatively, the control circuit may actively change the work port pressures for one or more of the hydraulic cylinders 140 while the boom assembly 28 is operated in the defined mode. This may reduce overall stress seen by a left boom arm 36 and/or a right boom arm 38 of the boom assembly 28.

However, in some cases, if the one or more actuators experiences an amount of movement exceeding a threshold within a defined time frame, the control circuit 150 can automatically lock out the pressure control valves 176, 178. In such instances, the computing system operably coupled with the control circuit may use the data provided by the actuator position sensors 92 to determine a length movement of the cylinder and/or a velocity of piston movement. In such instances, the system provided herein, can allow for fluid flow and/or cease fluid flow through the control circuit based at least in part on how well the boom assembly 28 is holding its target position.

As such, in some cases, the fluid control valve 192 may be upstream of the roll flow valve 172 and configured to allow a flow of hydraulic fluid in a first position to allow movement of the first roll actuator 86A and/or the second roll actuator 86B and restrict the flow of hydraulic fluid in a second position to lock the roll flow valve 172. Additionally or alternatively, the fluid control valve 192 may be upstream of the first fold pressure control valve 176 operably coupled with a first fold actuator 56A and the second fold pressure control valve 178 operably coupled with a first fold actuator 56A. The fluid control valve 192 may be configured to allow a flow of the hydraulic fluid in the first position for movement of first fold actuator 56A and restrict the flow of the hydraulic fluid in the second position to lock the first fold pressure control valve 176 operably coupled with a base port 148 of the first fold actuator 56A and the second fold pressure control valve 178 operably coupled with a rod port 146 of the first fold actuator 56A. Additionally or alternatively, the fluid control valve 192 may be upstream of the first fold pressure control valve 176 operably coupled the second fold actuator 56B and the second fold pressure control valve 178 operably coupled the second fold actuator 56B. The fluid control valve 192 may be configured to allow a flow of the hydraulic fluid in the first position to allow movement of second fold actuator and restrict the flow of the hydraulic fluid in the second position to lock the first fold pressure control valve 176 operably coupled with a base port 148 of the second fold actuator 56B and the second fold pressure control valve 178 operably coupled with a rod port 146 of the second fold actuator 56B. Additionally or alternatively, the fluid control valve 192 may be upstream of the first tilt pressure control valve 176 operably coupled with the first tilt actuator 70 and the second tilt pressure control valve 178 operably coupled with the first tilt actuator 70. The fluid control valve 192 may be configured to allow a flow of the hydraulic fluid in the first position for movement of first tilt actuator 70 and restrict the flow of the hydraulic fluid in the second position to lock the first tilt pressure control valve 176 operably coupled with a rod port 146 of the first tilt actuator 70 and the second tilt pressure control valve 178 operably coupled with a base port 148 of the first tilt actuator 70. Additionally or alternatively, the fluid control valve 192 may be upstream of the first tilt pressure control valve 176 operably coupled with the second tilt actuator 74 and the second tilt pressure control valve 178 operably coupled with the second tilt actuator 74. The fluid control valve 192 may be configured to allow a flow of the hydraulic fluid in the first position to allow movement of second tilt actuator 74 and restrict the flow of the hydraulic fluid in the second position to lock the first tilt pressure control valve 176 operably coupled with a rod port 146 of the second tilt actuator 74 and the second tilt pressure control valve 178 operably coupled with a base port 148 of the second tilt actuator 74.

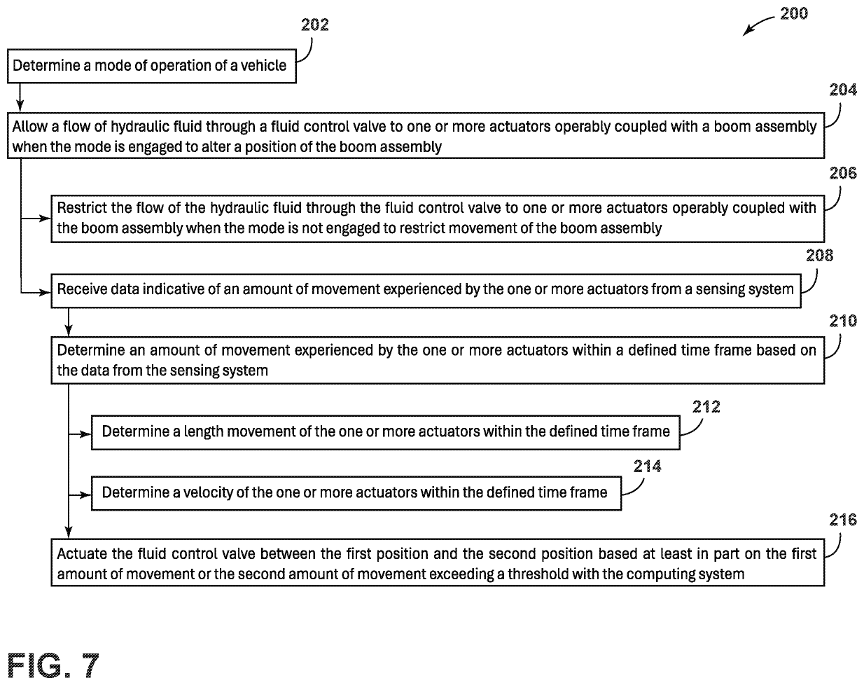

Referring now to FIG. 7, a flow diagram of some embodiments of a method 200 for an operation of a system for a boom assembly is illustrated in accordance with aspects of the present subject matter. In general, the method 200 will be described herein with reference to the vehicle 10 and the system 100 described above with reference to FIGS. 1-6C. However, the disclosed method 200 may generally be utilized with any vehicle 10 and/or may be utilized in connection with a system having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (202), the method 200 can include determining a mode of operation of a vehicle with a computing system. In various examples, input data may be received from input devices 104 to determine whether the boom assembly is being operating in a defined mode. In various instances, the defined mode may be an autoboom mode in which one or more actuators adjust a position of the boom assembly, and/or any other mode.

At (204), the method 200 can include allowing a flow of hydraulic fluid through a fluid control valve to one or more actuators operably coupled with a boom assembly when the mode is engaged to alter a position of the boom assembly. Conversely, at (206), the method 200 can include restricting the flow of the hydraulic fluid through the fluid control valve to one or more actuators operably coupled with the boom assembly when the mode is not engaged to restrict movement of the boom assembly.

At (208), the method 200 can include receiving data indicative of an amount of movement experienced by the one or more actuators from a sensor system. At (210), the method 200 can include determining an amount of movement experienced by the one or more actuators within a defined time frame based on the data from the sensor system. In some examples, at (212), the method 200 can include determining a length movement of the one or more actuators within the defined time frame. Additionally or alternatively, in some cases, at (214), the method 200 can include determining a velocity of the one or more actuators within the defined time frame. At (216), the method can include actuating the fluid control valve between the first position and the second position based at least in part on the first amount of movement or the second amount of movement exceeding a threshold with the computing system.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the adjustment model. In some instances, the vehicle learning engine may allow for changes to the adjustment model to be performed without human intervention.

It is to be understood that the steps of any method disclosed herein may be performed by a computing system upon loading and executing software code or instructions that are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions that are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A system comprising:
a boom assembly;
a mast operably coupled with the boom assembly;
a first roll actuator and a second roll actuator operably coupled with the boom assembly and the mast, wherein actuation of the first roll actuator or the second roll actuator causes the boom assembly to move relative to the mast;
a control circuit operably coupled with the first roll actuator and the second roll actuator, the control circuit comprising:
a roll flow valve fluidly coupled with a pressure line;
a roll directional control valve downstream of and fluidly coupled with the roll flow valve, the roll directional control valve further fluidly coupled with a tank line; and
a fluid control valve upstream of the roll flow valve and configured to allow a flow of hydraulic fluid in a first position to allow movement of the first roll actuator or the second roll actuator and restrict the flow of hydraulic fluid in a second position to lock the roll flow valve; and
a computing system operably coupled with the control circuit and configured to actuate the fluid control valve between the first position and the second position based at least in part on mode of operation of the boom assembly.

2. The system of claim 1, further comprising:
a first fold actuator operably coupled with a central boom section and a left boom arm, wherein the control circuit further comprises:
a first fold flow valve fluidly coupled with the pressure line;
a first fold directional control valve downstream of and fluidly coupled with the first fold flow valve, the first fold directional control valve further fluidly coupled with the tank line;
a first fold pressure control valve operably coupled with a rod port of the first fold actuator; and
a second fold pressure control valve operably coupled with a base port of the first fold actuator,
wherein the fluid control valve is upstream of the first fold pressure control valve operably coupled the first fold actuator and the second fold pressure control valve operably coupled the first fold actuator, the fluid control valve configured to allow a flow of the hydraulic fluid in the first position for movement of the first fold actuator and restrict the flow of the hydraulic fluid in the second position to lock the first fold pressure control valve operably coupled with a rod port of the first fold actuator and the second fold pressure control valve operably coupled with a base port of the first fold actuator.

3. The system of claim 1, further comprising:
a second fold actuator operably coupled with a central boom section and a left boom arm, wherein the control circuit further comprises:
a second fold flow valve fluidly coupled with the pressure line;
a second fold directional control valve downstream of and fluidly coupled with the second fold flow valve, the second fold directional control valve further fluidly coupled with the tank line;
a first fold pressure control valve operably coupled with a rod port of the second fold actuator; and
a second fold pressure control valve operably coupled with a base port of the second fold actuator,
wherein the fluid control valve is upstream of the first fold pressure control valve operably coupled the second fold actuator and the second fold pressure control valve operably coupled the second fold actuator, the fluid control valve configured to allow a flow of the hydraulic fluid in the first position to allow movement of the second fold actuator and restrict the flow of the hydraulic fluid in the second position to lock the first fold pressure control valve operably coupled with a rod port of the second fold actuator and the second fold pressure control valve operably coupled with a base port of the second fold actuator.

4. The system of claim 1, further comprising:
a first tilt actuator operably coupled with a central boom section and a left boom arm, wherein the control circuit further comprises:
a first tilt flow valve fluidly coupled with the pressure line;
a first tilt directional control valve downstream of and fluidly coupled with the first tilt flow valve, the first tilt directional control valve further fluidly coupled with the tank line;
a first tilt pressure control valve operably coupled with a rod port of the first tilt actuator; and
a second tilt pressure control valve operably coupled with a base port of the first tilt actuator,
wherein the fluid control valve is upstream of the first tilt pressure control valve and the second tilt pressure control valve, the fluid control valve configured to allow a flow of the hydraulic fluid in the first position for movement of the first tilt actuator and restrict the flow of the hydraulic fluid in the second position to lock the first tilt pressure control valve operably coupled with a rod port of the first tilt actuator and the second tilt pressure control valve operably coupled with a base port of the first tilt actuator.

5. The system of claim 1, further comprising:
a second tilt actuator operably coupled with a central boom section and a left boom arm, wherein the control circuit further comprises:
a second tilt flow valve fluidly coupled with the pressure line;
a second tilt directional control valve downstream of and fluidly coupled with the second tilt flow valve, the second tilt directional control valve further fluidly coupled with the tank line;
a first tilt pressure control valve operably coupled with a rod port of the second tilt actuator; and
a second tilt pressure control valve operably coupled with a base port of the second tilt actuator,
wherein the fluid control valve is upstream of the first tilt pressure control valve and the second tilt pressure control valve, the fluid control valve configured to allow a flow of the hydraulic fluid in the first position to allow movement of the second tilt actuator and restrict the flow of the hydraulic fluid in the second position to lock the first tilt pressure control valve operably coupled with a rod port of the second tilt actuator and the second tilt pressure control valve operably coupled with a base port of the second tilt actuator.

6. The system of claim 1, further comprising:
a sensor system operably coupled with the first roll actuator and the second roll actuator, the sensor system configured to generate data indicative of a first position of a first rod within the first roll actuator and a second position of a second rod within the second roll actuator.

7. The system of claim 6, wherein the computing system is further configured to:
determine a first amount of movement experienced by the first roll actuator within a defined time frame;
determine a second amount of movement experienced by the second roll actuator within the defined time frame; and
actuate the fluid control valve between the first position and the second position based at least in part on the first amount of movement or the second amount of movement exceeding a threshold.

8. The system of claim 7, wherein the sensor system comprises a first position sensor operably coupled with the first roll actuator and a second position sensor operably coupled with the second roll actuator.

9. The system of claim 8, wherein the first position sensor and the second position sensor are each configured as a linear position sensor.

10. The system of claim 1, wherein a base port of the first roll actuator is fluidly coupled with a rod port of the second roll actuator, and wherein a rod port of the first roll actuator is fluidly coupled with a base port of the second roll actuator.

11. A method for an operation of a system for a boom assembly, the method comprising:
determining, with a computing system, a mode of operation of a vehicle;
allowing, with the computing system, a flow of hydraulic fluid through a fluid control valve to one or more actuators operably coupled with a boom assembly when the mode is engaged to alter a position of the boom assembly; and
restricting, with the computing system, the flow of the hydraulic fluid through the fluid control valve to one or more actuators operably coupled with the boom assembly when the mode is not engaged to restrict movement of the boom assembly.

12. The method of claim 11, further comprising:
receiving, from a sensor system, data indicative of an amount of movement experienced by the one or more actuators.

13. The method of claim 12, further comprising:
determining, based on the data from the sensor system, an amount of movement experienced by the one or more actuators within a defined time frame.

14. The method of claim 13, wherein determining the amount of movement experienced by the one or more actuators within the defined time frame further comprises determining a length movement of the one or more actuators within the defined time frame.

15. The method of claim 13, wherein determining the amount of movement experienced by the one or more actuators within the defined time frame further comprises determining a velocity of the one or more actuators within the defined time frame.

16. The method of claim 13, further comprising:
actuating, with the computing system, the fluid control valve between a first position and a second position based at least in part on the amount of movement experienced by the one or more actuators exceeding a threshold.

17. A system comprising:
a boom assembly;
a first actuator and a second actuator operably coupled with the boom assembly and configured to alter a position of the boom assembly;
a sensor system operably coupled with the first actuator and the second actuator, the sensor system configured to generate data indicative of a position of a first rod within the first actuator and a position of a second rod within the second actuator;
a control circuit fluidly coupled with the first actuator and the second actuator, the control circuit comprising a fluid control valve configured to restrict a flow of hydraulic fluid in a first position to allow movement of the first actuator and the second actuator and restrict the flow of hydraulic fluid in a second position to allow movement of the first actuator and the second actuator; and
a computing system operably coupled with the control circuit and the sensor system, the computing system configured to:
determine a first amount of movement experienced by the first actuator within a defined time frame;
determine a second amount of movement experienced by the second actuator within the defined time frame; and
actuate the fluid control valve between the first position and the second position based at least in part on the first amount of movement or the second amount of movement exceeding a threshold.

18. The system of claim 17, wherein the computing system is further configured to actuate the fluid control valve between the first position and the second position based at least in part on mode of operation of the boom assembly.

19. The system of claim 17, wherein the first amount of movement includes a length movement of the first actuator within the defined time frame.

20. The system of claim 17, wherein the first amount of movement includes a velocity of the first actuator within the defined time frame.
